(19) United States
(12) Patent Application Publication
(10) Pub. No.: US 2006/0287016 A1
(43) Pub. Date: Dec. 21, 2006

(54) Modular beamforming apparatus, method and kit

(75) Inventors: James David Portaro, Bruceton Mills, WV (US); Robert F. Meyerson, Akron, OH (US)

Correspondence Address: Christopher Alder, 1328 Holly St. NW, Washington, DC, 20012, US

(73) Assignee: ATEN-Air, LLC, Akron, OH (US)

(21) Appl. No.: 11/155,238

(22) Filed: Jun. 17, 2005

(51) Int. Cl. H04B 1/08; H04M 1/00

(52) U.S. Cl. 455/575.7; 455/349

(57) ABSTRACT

The present invention relates to a beamforming apparatus for use in combination with a existing WLAN comprising: an antenna control unit; at least one antenna operatively connected to said antenna control unit; an RJ-45 jack operatively connected to said antenna control unit; a power supply operatively connected to said antenna control unit; and a wireless access point jack operatively connected to said antenna control unit.

### TECHNICAL FIELD

The present invention relates generally to communication systems, and more specifically to a novel apparatus, kit and method useful for improving the performance of a WLAN system.

### BACKGROUND OF THE INVENTION

Wireless local area networks (“WLAN”) systems are widely used to enable various types of communication including voice and data transmission and reception. WLANs use antennas to transmit and receive data. Many WLANs comprise a plurality of antennas. Relative to a communication system comprising only one antenna, a communication system comprising a plurality of antennas may afford: 1) an increase in the information throughput rate, or 2) an increase in spectral efficiency. A plurality of antennas may be referred to as an antenna array.

Many WLANs comprise a plurality of interconnected fixed access points, which may be collectively referred to as a system backbone. Many WLANs further comprise wireless access points. As used herein, “AP” means access point and may refer to fixed access points or wireless access points. Wireless APs perform many of the same functions as fixed APs. Wireless APs may increase the area within which an AP connected to the system backbone can communicate with mobile client devices including cellular telephones, pagers, or personal digital assistants.

FCC, IEEE and 802.11 rules, regulations and standards limit wireless communication systems to certain available RF bandwidth, thus requiring the continuing reuse of available RF bandwidth. The reuse of available RF bandwidth by increasing numbers of clients or by existing clients seeking higher transmission quality may create interference in the absence of devices and methods to improve spectral efficiency.

802.11 refers to a family of physical interface specifications developed by the Institute of Electrical and Electronics Engineers for WLAN technology. 802.11 standards specify the physical interface between a wireless client and a base station, or between two wireless clients. 802.11a standards apply to wireless WLANs providing up to 54 Mbps in the 5 GHz band. 802.11b standards apply to WLANs providing up to 11 5.5, 2 or 1 Mbps transmission in the 2.4 GHz band. 802.11g standards apply to LANs providing up 20+ Mbps in the 2.4 GHz band.

An RF channel is defined by its frequency, time slot, or its code. To allow more than one user to transmit over the same RF channel certain spatial divisibility methods have been proposed including TDM (time division multiplexing), FDMA (frequency division multiplexing), and SDM (space division multiplexing).

Medium Access Control (MAC) layer protocols are defined to coordinate the channel usage for WLAN users sharing the band. These MAC layer protocols are based upon avoiding collisions between users as several users access the channel at the same time. The efficiency of a protocol is gauged in part by successful avoidance of collisions.

A long-standing problem in the WLAN industry is the need to maximize spectral efficiency. Maximization of spectral efficiency refers to the most efficient use of a finite bandwidth. WLANs must be designed to transmit within a defined bandwidth and must minimize interference with other frequencies of the spectrum. Competing with the need to transmit within a narrowly defined bandwidth is the desire to maximize the signal throughput. A goal of WLAN system design is to use the available spectrum in the most efficient manner possible. As client density increases, WLANs must employ additional access points or employ existing APs in a more efficient manner in order to maintain signal integrity.

Some WLANs comprise an omni-antenna. An omni-antenna transmits signals in all directions, essentially away from the antenna in a spherical pattern; this wide signal scattering may decrease transmission distance, introduce spurious emissions, or may create interference with other signals. Spurious emissions from omni-antennas may create interfering signals, increase signal fading or decrease signal range.

Some WLANs comprise a micro-strip antenna. Micro-strip antennas are suitable for devices requiring small antennas transmitting on high frequencies, for example in the MHz to GHz range. U.S. Pat. No. 6,262,682 to Shibata refers to a micro-strip antenna and is incorporated by reference herein. U.S. Pat. No. 6,084,548 to Hirabe refers to a micro-strip antenna and is incorporated by reference herein.

Some WLANs comprise a smart antenna. Smart antennas have been introduced as a means of increasing throughput capacity. As used herein, “smart antenna” means any antenna capable of controlling the direction in which signals are transmitted or the direction from which signals are received. Processors in WLANs comprising smart antennas transmit or receive over multiple signal paths; by applying amplitude weights to the energy passing through each path the resulting radiation pattern can be directionalized so that significantly more signal is transmitted in or received from certain angular directions relative to other angular directions. Throughout the present application, it should be kept in mind that principles and discussions relating to the transmission of signals apply equally to the reception of signals. U.S. Pat. No. 6,816,116 to Chen refers to smart antennas and is incorporated by reference herein. U.S. Pat. No. 6,795,018 to Guo refers to smart antennas and is incorporated by reference herein.

One technique used with communication systems to increase signal efficiency is Multiple Input Multiple Output (“MIMO”). MIMO techniques use a plurality of antennas coupled to a signal processing chipset for the simultaneous transmission and/or reception of multiple signals. MIMO allows exploitation of the spatial dimension to improve the performance of wireless signal transmission. MIMO provides antenna diversity against undesirable path effects and improves efficiency. As transmission paths between the transmit antennas and receive antennas are generally linearly independent the probability of successful transmission of signal to a client increases in proportion to the number of antennas. U.S. Pat. No. 6,785,341 to Walton, et al refers to MIMO devices and methods and is incorporated by reference herein.

Another technique used with communication systems to increase signal efficiency is an apparatus comprising smart-antennas that use beamforming technology to create a directionalized signal. As used herein, the term “beamforming” means formation of a directionalized signal. Forming directionalized signals in WLAN systems may result in reduced spurious emissions or higher signal efficiency to the mobile client. Some devices apply beamforming technology to enhance signal amplitude relative to background noise and directional interference. U.S. Pat. No. 6,850,190 to Ryu, et al refers to beamforming devices and methods and is incorporated by reference herein. U.S. Pat. No. 6,839,573 to Youssefmir, et al refers to beamforming devices and methods and is incorporated by reference herein. U.S. Pat. No. 6,778,507 to Jalali refers to beamforming devices and methods and is incorporated by reference herein.

Another technique used with communication systems to increase signal efficiency comprises a plurality of selectively activatable antennas arranged in an antenna array. Such an antenna array comprises an antenna control unit capable of measuring signal strength of an incoming signal, selecting which of the particular antennas has the greatest potential signal power and weighting the corresponding outgoing signal where the activation of any particular antenna is a function of the potential signal efficiency of that particular antenna relative to other antennas in the array. Arrays comprising at least two selectively activatable antennas are capable of forming a directionalized signal.

Replacement of existing omni-antenna transmitters with more efficient antennas capable of forming a directionalized signal would provide for the more efficient use of available bandwidth. Unfortunately, as a large number of devices comprising omni-antennas are currently deployed, the replacement of existing base stations comprising omni-antenna technology is expensive and time-consuming. A modular beamforming apparatus capable of coupling with existing access points that could increase the performance and capacity of a WLAN system would represent a great advance in the art.

### BRIEF SUMMARY OF THE INVENTION

There is now provided a modular beamforming apparatus comprising:
an antenna control unit;
at least two antennas operatively connected to said antenna control unit;
an Ethernet jack operatively connected to said antenna control unit;
a power supply operatively connected to said antenna control unit; and
a wireless access point jack operatively connected to said antenna control unit.

As used herein, “modular” refers to the separable nature of apparatuses described in the present disclosure. One embodiment of the present invention provides a modular beamforming apparatus suitable for connection to an existing WLAN. Another embodiment provides a modular beamforming apparatus suitable for connection to a WLAN where the WLAN does not comprise a smart antenna. Another embodiment provides a modular beamforming apparatus suitable for connection to a WLAN where the WLAN does not comprise a means for forming a directionalized signal.

One embodiment of the present invention provides an apparatus that will integrate with existing 802.11a/b/g wireless APs comprising an external antenna connector.

Another embodiment of the present invention provides an apparatus that is capable of being integrated into a new 802.11a/b/g WLAN design.

Another embodiment of the present invention provides an apparatus further comprising a security layer, for example, a MAC security layer. As used herein “MAC” an abbreviation for Media Access Control, means a method for controlling access to a transmission medium. One exemplary method of for controlling access to a transmission is the Ethernet CSMA/CD access method.

Another embodiment of the present invention provides a kit capable of coupling to existing WLANs comprising an antenna control unit, at least one antenna coupled to said antenna control unit, an ethernet jack coupled to said antenna control unit, a power supply jack coupled to said antenna control unit, and an 802.11a/b/g wireless AP jack coupled to said antenna control unit.

Another embodiment of the present invention provides a A modular beamforming apparatus for use in combination with a preexisting WLAN antenna, said apparatus comprising:
a. an antenna control unit;
b. at least two antennas operatively connected to said antenna control unit;
c. a RJ-45 jack operatively connected to said antenna control unit;
d. a power supply operatively connected to said antenna control unit; and,
e. a wireless access point jack operatively connected to said antenna control unit.

Another embodiment of the present invention provides a process of forming a directionalized outgoing signal comprising the steps of:
a. connecting a modular beamforming apparatus to a wireless access point, where said apparatus comprises:
   i. an antenna control unit;
   ii. at least two antennas operatively connected to said antenna control unit;
   iii. a RJ-45 jack operatively connected to said antenna control unit;
   iv. a power supply operatively connected to said antenna control unit; and,
   v. a wireless access point jack operatively connected to said antenna control unit,
b. measuring signal strength of an incoming signal;
c. selecting which of the at least two antennas has greatest potential signal power;
d. selectively activating the antenna having the greatest potential signal power; and,
e. forming a directionalized outgoing signal.

Another embodiment of the present invention provides a kit for forming a directionalized signal comprising:
a. a modular beamforming apparatus; and,
b. one plenum rated RG172 coaxial cable
c. wherein the modular beamforming apparatus comprises:
   i. an antenna control unit;
   ii. at least two antennas operatively connected to said antenna control unit;
   iii. a RJ-45 jack operatively connected to said antenna control unit;
   iv. a power supply operatively connected to said antenna control unit; and,
   v. a wireless access point operatively connected to said antenna control unit.

Embodiments of the present invention may provide one or more benefits that include, but are not limited to one or more of the following:
compliant with 802.11 standards;
extends transmission range;
decrease in RF spatial interference;
increase in RF bandwidth available to the mobile client;
increase in signal throughput;
enhanced wireless VOIP connectivity;
increase in RF bandwidth throughout the enterprise;
increase in the range of effective RF from the RF AP to the mobile client; and,
applicable to existing WLAN systems.

### BRIEF DESCRIPTION OF THE DRAWINGS

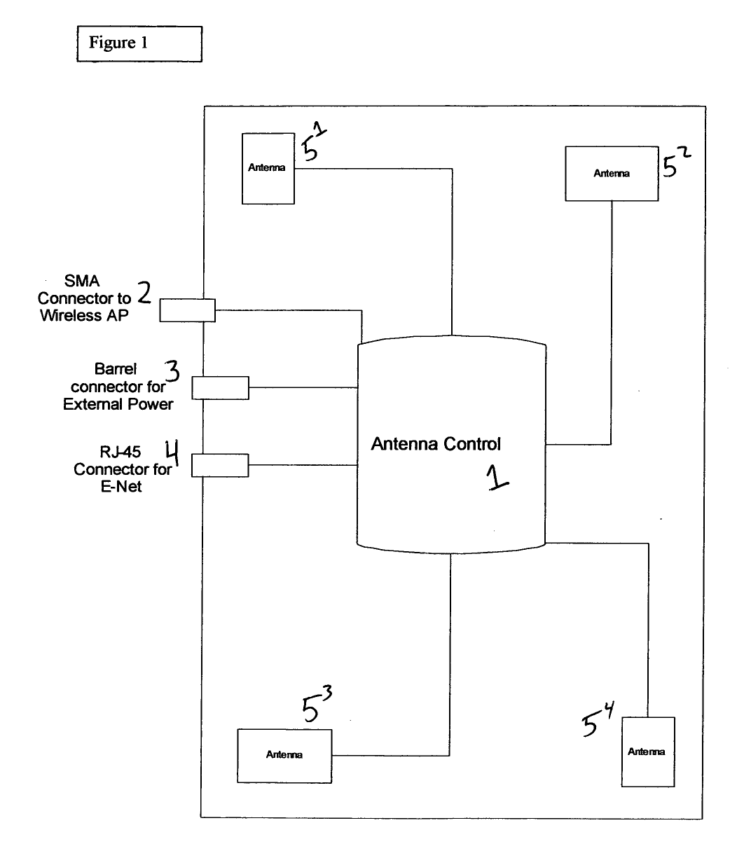

An exemplary embodiment of the present invention is depicted in FIG. 1, showing a block diagram of a modular beamforming apparatus.

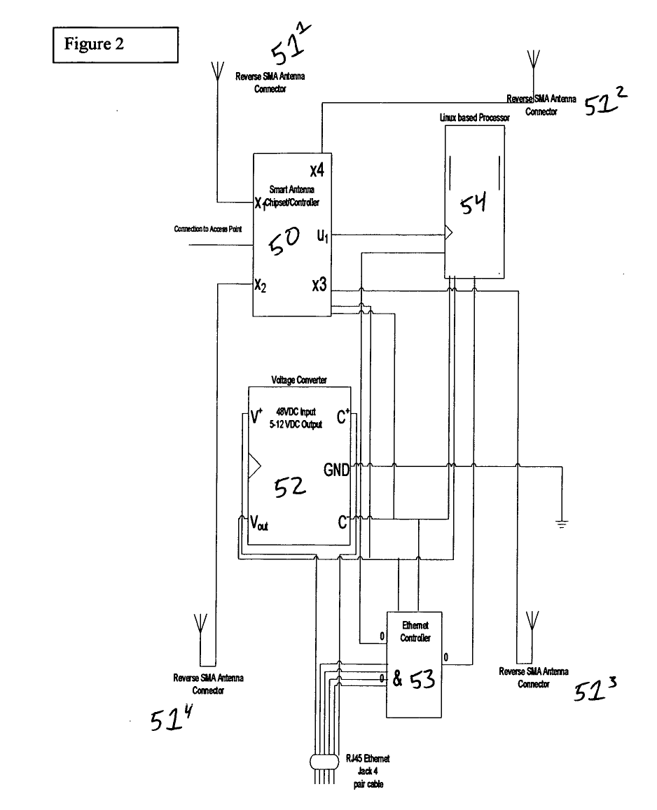

Another exemplary embodiment of the present invention is depicted in FIG. 2, showing a block diagram of a modular beamforming apparatus.

### DETAILED DESCRIPTION OF THE INVENTION

Referring to FIG. 1, Antenna control unit (1) is operatively connected to: SMA connector to wireless AP (2); barrel connector for external power (3); RJ-45 Ethernet jack (4); and, a plurality of antennae (5¹, 5², 5³, 5⁴).

Antenna control unit (1) is a processor selected to minimize interference between upstream and downstream signals through systems including Time Division Duplex systems (TDD) and Frequency Division Duplex systems (FDD). TDD systems divide transmission time in a single channel into slots that are used to convey upstream and downstream data in alternating periods. The allocation of slots to either upstream transmission or downstream transmission can be optimized pursuant to client demands. FDD systems provide an upstream and downstream channel between the AP and the client.

In some embodiments of the present invention, the antenna control unit comprises a chipset for controlling a plurality of antenna. In one embodiment of the present invention, the plurality of antenna consists of 1 to 8 antennas. In another embodiment, the plurality of antenna consists of 4 antennas. In another embodiment, the chipset has a configurable operating system. In another embodiment, the chipset comprises signal to noise ratio (SNR) adjustments. In another embodiment, the chipset comprises receiver signal strength indicator (RSSI) adjustments. In another embodiment, the chipset comprises 802.11 beacon spoofing for Intrusion Detection System, rogue client take out. In another embodiment, the chipset comprises 802.11 beacon spoofing for IDS, rogue Access Point take out. In another embodiment, the chipset comprises radio frequency triangulation for local positioning systems. In another embodiment, the chipset comprises an upgradeable firmware operating system.

Connector to Wireless Access Point (2) is a physical interface for a reverse polarity connector. In a preferred embodiment of the present invention, the Connector to Wireless Access Point (2) is a Reverse SMA connector.

A barrel connector for external power (3) is a physical interface for a power source. In one embodiment of the present invention, the power source is a Power Over Ethernet (“POE”) tap. In one embodiment of the present invention, the power source is an external power supply.

A RJ-45 connector for Ethernet connectivity (4) is a physical interface for 4 pair cable types.

Antennas (5¹, 5², 5³, 5⁴) are an array of linearly polarized antenna positioned fractions of wavelengths apart. In one embodiment of the present invention, each antenna is individually capable of transmitting and receiving RF signals. A number of antenna arrangements are known in the art. The positioning and arrangement of both antennas within an array, and the array itself will vary depending on system requirements and it will be appreciated by those skilled in the art that various possible positioning and arrangements have broad application to smart antenna systems.

Referring to FIG. 2, Smart Antenna Chipset (50) is operatively connected to: four Reverse SMA Antenna Connectors (51¹, 51², 51³, 51⁴), Voltage Converter (52), Ethernet Controller (53) and Processor (54). Voltage Converter (52) is operatively connected to ground, Smart Antenna Chipset (50), Ethernet Controller (53), RJ-45 Ethernet jack (55) and Processor (54). Ethernet Controller (53) is operatively connected to Processor (54), Voltage Converter (52), and RJ-45 Ethernet jack (55). Processor (54) is operatively connected to Voltage Converter (52), Smart Antenna Chipset (50), Ethernet Controller (53). RJ-45 Ethernet jack (55) is operatively connected to Ethernet Controller (53) and Voltage Converter (52).

One embodiment of the present invention provides an apparatus comprising an antenna support structure.

The present description disclosing an apparatus with four antennas is intended to be only an illustrative example, it should be understood that the present invention contemplates an apparatus with N antennas where N is an integer greater than 1. In one embodiment of the present invention, a beam forming apparatus comprises 2-16 antennas. In another embodiment of the present invention, a beam forming apparatus comprises 2-8 antennas. In another embodiment of the present invention, a beam forming apparatus comprises 4 antennas.

One embodiment of the present invention provides a microstrip antenna, where a microstrip antenna comprises a plurality of antennas.

One embodiment of the present invention provides an apparatus comprising a plurality of selectively activatable antennas where the activation of any particular antenna is a function of the potential signal efficiency of that particular antenna relative to other antennas in the array. An apparatus comprising a selectively activatable antenna is capable of directionalizing a signal to a mobile client.

In one embodiment of the present invention, a modular beamforming apparatus comprising a plurality of antennas coupled to an antenna control unit is capable of measuring the strength of each incoming signal and adjusting a directionalized output signal targeting the mobile client. In another embodiment, a modular beamforming apparatus is capable of directing a signal within about 50 feet of a mobile client. In another embodiment, a modular beamforming apparatus is capable of directing a signal within about 25 feet of a mobile client. In another embodiment, a beamforming apparatus is capable of directing a signal within about 10 feet of a mobile client.

In one embodiment of the present invention, a beamforming apparatus is capable of increasing RF gain between an AP to the mobile client by about 5 dB to about 50 dB. In another embodiment, a beamforming apparatus is capable of increasing RF gain between an AP to the mobile client by about 8 dB to about 30 dB. In another embodiment, a beamforming apparatus is capable of increasing RF gain between an AP to the mobile client by about 10 dB to about 20 dB.

In one embodiment of the present invention, a beamforming apparatus increases spatial efficiency by about 1 bit/s/Hz/m³ to about 10 bits/s/Hz/m³. In another embodiment, a beamforming apparatus increases spatial efficiency by about 2 bit/s/Hz/m³ to about 7 bits/s/Hz/m³. In another embodiment, a beamforming apparatus increases spatial efficiency by about 4 bit/s/Hz/m³ to about 6 bits/s/Hz/m³. In another embodiment, a beamforming apparatus increases spatial efficiency by about 5 bit/s/Hz/m³.

In one embodiment of the present invention, a beamforming apparatus provides at least a 40% increase in effective RF bandwidth available to the mobile client. In another embodiment of the present invention, a beamforming apparatus provides at least a 60% increase in effective RF bandwidth available to the mobile client. In another embodiment of the present invention, a beamforming apparatus provides at least an 80% increase in effective RF bandwidth available to the mobile client.

In one embodiment of the present invention, a beamforming apparatus provides at least a 40% increase in effective RF bandwidth throughout the enterprise. In another embodiment of the present invention, a beamforming apparatus provides at least a 60% increase in effective RF bandwidth throughout the enterprise. In another embodiment of the present invention, a beamforming apparatus provides at least an 80% increase in effective RF bandwidth throughout the enterprise.

In one embodiment of the present invention, a beamforming apparatus provides at least a 40% increase in wireless VoIP connectivity. As used herein, the term “VoIP” means voice over internet protocol. In another embodiment of the present invention, a beamforming apparatus provides at least a 60% increase in wireless VoIP connectivity. In another embodiment of the present invention, a beamforming apparatus provides at least an 80% increase in wireless VoIP connectivity.

In certain applications of the present invention, it is desirable to contain the majority of the apparatus in a housing. In one embodiment of the present invention, a beamforming apparatus capable of coupling with existing access points further comprises a housing no larger than about 30 cm long, about 20 cm wide and about 5 cm thick. In another embodiment, a modular beamforming apparatus capable of coupling with existing access points further comprises a housing no larger than about 20 cm long, about 12 cm wide and about 2 cm thick.

Some embodiments of the present invention provide an apparatus comprising means for forming a directionalized signal. In one embodiment, the means for forming a directionalized signal comprises an adaptive array. In another embodiment, the means for forming a directionalized signal comprises a beamforming means. Japanese Patent Document 9(1997)-238105 discuss technologies for controlling beams radiated by a directional antenna, which is set in a base transceiver station, so that a beam is directed to a mobile station with a high precision. Document 9(1997)-238105 discusses a directional antenna controlled so that a beam is radiated to a direction in which a level of a signal transmitted from a mobile station is high, and thus the beam is directed to the mobile station with a high precision. Japanese Patent Document No. 7(1995)-87011 also discusses technologies for controlling beams radiated by a directional antenna, which is set in a base transceiver station, so that a beam is directed to a mobile station with a high precision. Document 7(1995)-87011 refers to a directional antenna is controlled so that a beam is radiated to a direction in which a level of a signal transmitted from a mobile station is high; a position of each of the mobile stations is estimated based on position information, and a directional antenna is controlled so as to radiate a beam to the estimated position, and thus, the beam is directed to each mobile station with high precision.

One embodiment comprises an adaptive array comprising at least one antenna, a first phase control circuit for transmission of data packets, a second phase control circuit for transmission of data packets, a distributor for distributing the transmission data packet to one of the first and second phase control circuits based on a client location, and a phase shift amount control circuit controlling the amount of phase shift of the first and second phase control circuits based on the client location.

An adaptive antenna system may achieve a high degree of directionalized beam accuracy by varying the phase and amplitude components of a transmitted wave. More specifically, phases and magnitudes of a set of transmitted waves, emanating from an array of antenna elements of a transceiver, are varied by weighting individual elements in the array such that an antenna radiation pattern, for example the antenna radiation pattern of a base site, is optimized to match prevailing signal and interference environments of a related coverage area, such as a cell. The beam pattern of an antenna array is determined to a large extent by the beamforming weights. There are a number of well-known weight distributions, including Taylor and Chebyshev distributions.

Many techniques have been proposed for adaptively forming an antenna array beam pattern. A number of these techniques provide for focusing an antenna array beam in the direction of maximum signal strength received by the base site from the mobile client. That is, the techniques determine a separate amplitude and phase adjustment for each portion of a signal received from a subscriber unit via each of the plurality of antennas before the signal portions are combined, thereby allowing the base site to resolve the received signal and interfering signals, nulling out the interfering signals and optimizing the received signal. When the base site transmits a signal to the mobile client, the amplitude and phase adjustments that are determined based on the received signal are in turn applied to each portion of the signal that is being transmitted by each of the plurality of antennas.

The use of adaptive antennas may be used to reduce received interference by directed reception, to reduce generated interference by directed transmission, to reduce time dispersion of a mobile RF channel, or to reduce intersymbol interference decisively codetermining the bit error rate.

Directionalized beamforming may be used to increase capacity gain, to increase spectral efficiency, to reduce necessary transmission power by an antenna array gain, to improve transmission quality, to reduce bit error rate, to increase the data rate, or to extend the transmission range.

The present invention further provides methods, kits, and apparatuses that implement various aspects, embodiments, and features of the invention, as described in further detail herein.

What is claimed is:

1. A modular beamforming apparatus comprising:
a. an antenna control unit;
b. two to eight antennas operatively connected to said antenna control unit;
c. a RJ-45 jack operatively connected to said antenna control unit;
d. a power supply operatively connected to said antenna control unit; and,
e. a wireless access point jack operatively connected to said antenna control unit.

2. The apparatus of claim 1 further comprising a means for selecting which of the at least two antennas has greatest potential signal power.

3. The apparatus of claim 1 further comprising a means for forming a directionalized signal.

4. The apparatus of claim 1 wherein said two to eight antennas consists of four antennas.

5. The apparatus of claim 1 wherein the existing access point is selected from the group consisting of: an 802.11a access point, an 802.11b access point, and an 802.11g access point.

6. The apparatus of claim 1 wherein the at least one antenna is linearly polarized.

7. The apparatus of claim 1 wherein the power supply is a connector to an external power source.

8. The apparatus of claim 1 wherein the power supply is a POE tap.

9. The apparatus of claim 1 wherein the power supply comprises a connector for an 18 g 3 conductor plenum rated cable to the RJ-45 jack.

10. The apparatus of claim 1 wherein the power supply comprises a voltage converter having an output of about 5 volts to about 12 volts.

11. The apparatus of claim 1 wherein the wireless access point jack is an 802.11a/b/g wireless access point port.

12. The apparatus of claim 1 further comprising an Ethernet controller and a processor, wherein said Ethernet controller is operatively connected to said antenna control unit, said RJ-45 jack, and said power supply, and wherein said processor is operatively connected to said antenna control unit, said RJ-45 jack, and said power supply.

13. The apparatus of claim 1 further comprising a support structure physically supporting the at least one antenna.

14. The apparatus of claim 1 further comprising a MAC security layer.

15. A process of forming a directionalized outgoing signal comprising the steps of:
a. connecting a modular beamforming apparatus to a wireless access point,
where said apparatus comprises:
1. an antenna control unit;
2. at least two antennas operatively connected to said antenna control unit;
3. a RJ-45 jack operatively connected to said antenna control unit;
4. a power supply operatively connected to said antenna control unit; and,
5. a wireless access point jack operatively connected to said antenna control unit,
b. measuring signal strength of an incoming signal;
c. selecting which of the at least two antennas has greatest potential signal power;
d. selectively activating the antenna having the greatest potential signal power; and,
b. forming a directionalized outgoing signal.

16. The process of claim 15 wherein said modular beamforming apparatus further comprises an Ethernet controller and a processor, wherein said Ethernet controller is operatively connected to said antenna control unit, said RJ-45 jack, and said power supply, and wherein said processor is operatively connected to said antenna control unit, said RJ-45 jack, and said power supply.

17. A kit for retrofitting a WLAN omni-directional transmitter comprising:
a. a modular beamforming apparatus; and,
b. one plenum rated RG172 coaxial cable
wherein the modular beamforming apparatus comprises:
1. an antenna control unit;
2. at least two antennas operatively connected to said antenna control unit;
3. a RJ-45 jack operatively connected to said antenna control unit;
4. a power supply operatively connected to said antenna control unit; and,
5. a wireless access point jack operatively connected to said antenna control unit,

18. The kit of claim 17 further comprising an Ethernet controller and a processor, wherein said Ethernet controller is operatively connected to said antenna control unit, said RJ-45 jack, and said power supply, and wherein said processor is operatively connected to said antenna control unit, said RJ-45 jack, and said power supply.
